(19) United States
(12) Patent Application Publication
(10) Pub. No.: US 2017/0055454 A1
(43) Pub. Date: Mar. 2, 2017

(54) ADJUSTABLE GRAIN CART AUGER

(71) Applicant: Kinze Manufacturing, Inc., Williamsburg, IA (US)

(72) Inventors: Daryl Michael, Williamsburg, IA (US); Vaughan Stevenson, Williamsburg, IA (US); Chad Janssen, Williamsburg, IA (US)

(21) Appl. No.: 15/246,653

(22) Filed: Aug. 25, 2016

Related U.S. Application Data
(60) Provisional application No. 62/209,605, filed on Aug. 25, 2015.

(51) Int. Cl. A01D 90/10; B60P 1/42; B65G 33/34; A01B 73/00; B65G 33/10; B65G 33/14

(52) U.S. Cl. CPC A01D 90/10; B65G 33/10; B65G 33/14; B65G 33/34; A01B 73/00; B60P 1/42

(57) ABSTRACT

An agricultural wagon for moving particulate material from within the wagon to a separate storage vessel is provided. The wagon includes a bin defined by walls. The wagon may also include one or two augers, such as a floor and lift auger for moving the material from within the bin to the storage vessel. The floor auger may include a hydraulically controlled flow gate assembly for selectively covering the floor auger. The lift auger is foldable and includes an adjustable hinge assembly to attach an upper and lower section of the auger. The hinge assembly includes slotted holes for adjustment, such that the upper auger section may be moveable relative to a lower auger section. The lift auger may further be moveable relative to the bin such that it can dispense the material from either the left or right sides of the bin.

### CROSS-REFERENCE TO RELATED APPLICATIONS

This application claims priority under 35 U.S.C. §119 to Provisional Application Ser. No. 62/209,605, filed on Aug. 25, 2015, the contents of which are hereby incorporated by reference in its entirety.

### FIELD OF THE INVENTION

The invention relates generally to mobile carts for receiving, transporting and offloading particulate material. More particularly, but not exclusively, the invention relates to an agricultural wagon with an adjustable folding auger.

### BACKGROUND OF THE INVENTION

Agricultural wagons, such as grain carts, aid in the harvesting of agricultural products such as corn, beans, or other crop (collectively “particulate material”). The grain carts are configured to receive the harvested grain from a combine or other implement so that the combine can continue to harvest the grain. Many times, a grain cart will move alongside a combine as the combine harvests grain so that the combine can deliver harvested grain to the cart such that the combine will be able to continue to harvest without having to stop to empty its hopper or hoppers. Once the combine hopper has been transported to the grain cart, the grain cart is able to transport the grain to a storage or transport vessel, such as a semi-trailer or grain silo.

Augers are generally used to transport the grain from the grain cart to the storage vessel. A vertical or lift auger is positioned on or in the grain cart with one end in or near the grain, and the other end extending generally upwardly and outwardly from the cart. The positioning of the lift auger allows the grain to be moved from the storage area of the grain cart to the trailer. The lift auger may also be adjustable or movable such that the auger can be directed to aim the grain towards trailers of differing heights, sizes, or the like. The adjustability also allows the grain to be directed to exact locations within the trailer or area.

Early grain cart designs placed the lift, unloading, or discharge auger at the side of the wagon's bin. Later designs located the unloading auger on a front corner of the bin to position the discharge end of the unloading auger in a location more easily seen by the operator of a tractor pulling the grain cart. To reduce the size of the grain cart for facilitating storage and transport to and from a field, the unloading auger is typically comprised of upper and lower sections, which are pivotally coupled, such as by a hinge. The upper auger section is adapted for folding to a position in closely spaced relation to the cart's bin. In the case of a side discharge grain cart, the upper section of its folding auger is not clearly visible to the vehicle operator who must be careful to avoid contact between the auger and the offloading truck. This generally requires the operator to unfold the auger well away from the truck and to then move the cart into position relative to the truck for unloading. This latter operation is rendered more difficult by exhaust pipes and other structures, which frequently project upward, from larger trucks. Grain carts with the auger located in a corner overcome this problem by folding the upper auger section across the front of the cart to allow the operator to clearly see the auger as it is moved to the extended, or operating, position.

Folding augers have traditionally included a fixed hinge for coupling the upper and lower sections of a folding auger. The hinge allows the upper section to be pivoted about the lower section, and a hydraulic cylinder is commonly used as the means to actuate the pivoting movement. The cylinder may include a piston rod with a threaded clevis to provide for adjustment of the length of the piston rod. However, a fixed hinge with a cylinder including a threaded clevis only provides for minimal angular/rotational adjustment of the top section of the folding auger relative to the bottom section of the auger. The traditional hinge is referred to as a fixed hinge because the components that make up the hinge utilize circular holes fitted to the fasteners for assembly and attachment. Therefore, this configuration will provide only minimal adjustment related to the points of engagement of the upper and lower sections of the auger when in the unfolded, or operating position. Even with adhering to tight tolerances in manufacturing, the traditional configuration can still result in an imperfect fit or engagement between the upper section and the lower section of the auger at the point of contact.

Therefore, there is a need in the art for an agricultural wagon that includes a folding auger that has an adjustable hinge for connecting the upper and lower sections of the auger, to provide a better seal/fit at the point of engagement between the upper and lower sections of the auger.

### BRIEF SUMMARY OF THE INVENTION

Therefore, it is a primary object, feature, and/or advantage of the invention to improve on and/or overcome the deficiencies in the art.

It is another object, feature, and/or advantage of the invention to provide an improved mobile cart for receiving, transporting, and offloading particulate material such as grain when used in agricultural applications.

It is yet another object, feature, and/or advantage of the invention to provide an agricultural cart that includes a lift auger that can be folded between a transport position and an extended position.

It is a further object, feature, and/or advantage of the present invention to provide a folding lift auger with an adjustable hinge assembly that allows for axial adjustment of the upper section of the folding auger relative to the lower section of the folding auger.

These and/or other objects, features, and advantages of the invention will be apparent to those skilled in the art. The invention is not to be limited to or by these objects, features and advantages. No single embodiment need provide each and every object, feature, or advantage.

Accordingly, an aspect of the invention includes an agricultural wagon, which may be known as a grain cart. The grain cart includes a storage bin defined by front, rear, and opposing side walls. The cart may also have a floor for holding a particulate material, wheels for supporting the bin, as well as a tongue, hitch, or other member for attaching the cart to a vehicle, such as a tractor. The cart may include a first auger, which may also be known as a floor auger. The floor auger can be positioned within the bin, or outside the bin with a hole in the floor to allow the material to flow to the floor auger. The floor auger is configured to move the material in a generally forward or rearward manner and towards a second or lift auger, which is operatively connected to and in communication with the floor auger. The floor auger may also include a flow gate assembly. The flow gate assembly may selectively cover the floor auger and is positioned adjacent the floor auger within the storage bin. The flow gate assembly includes a door, a plurality of links connected to the door, a plurality of crank arms connected to the links, and a cylinder operatively connected to the crank arms. The cylinder includes an extended position whereby the door is raised to allow grain to flow towards the floor auger.

The lift auger is configured to move the particulate material from the storage bin to another vessel outside of the grain cart, and can be positioned adjacent the front or rear of the cart. In addition, the lift auger is configured to be movable relative to the sides of the cart. For example, the lift auger is movable in a generally side-to-side manner and can be positioned at either the front or the rear corner of the grain cart. When the lift auger is positioned at the front of the cart, the auger can be moved from one front corner to the other, making the dispensement of the particulate material occur on either the left or right side of the grain cart when viewed in relation to the direction of travel of the cart and vehicle. This allows the position of the lift auger to be positioned at the left, front corner of the cart, as is common, or also at the right, front corner.

Additionally, the lift auger may include a pivot along the length of the auger. The pivot allows the auger to be folded to a position generally in front of or behind the grain cart such that, in a transport or folded position, the auger is folded generally within the front or rear profile of the grain cart. When needed for delivering the material from the cart, the auger can become unfolded to extend the auger above and away from the storage bin such that the hood of the auger can direct the material from the auger and towards/into a storage vessel.

Additionally, the present invention further includes an adjustable hinge assembly that allows the lift auger to be folded. The adjustable hinge assembly may include slotted holes to provide axial adjustment of an upper section of the auger relative to a lower section of the auger when the auger is unfolded. The axial adjustment provided by the hinge assembly allows for more uniform engagement of the upper and lower sections of the auger at the point of contact when the auger is in the unfolded position.

### BRIEF DESCRIPTION OF THE DRAWINGS

FIG. 1 is a perspective view of an agricultural wagon with a folding auger.

FIG. 2 is a side view of the agricultural wagon with a folding auger of FIG. 1.

FIG. 3 is a top view of the agricultural wagon with a folding auger of FIG. 1.

FIG. 4 is a front view of an agricultural wagon with a folding auger in a folded position.

FIG. 5 is a front view of an agricultural wagon with a folding auger in an extended position.

FIG. 6 is a top view of an adjustable hinge assembly.

FIG. 7 is a side view of the adjustable hinge assembly of FIG. 6.

FIG. 8 is a perspective view of an adjustable hinge component including slotted holes.

FIG. 9A is a front view of an agricultural wagon with the folding auger on the left side of the agricultural wagon.

FIG. 9B is a front view of an agricultural wagon with the folding auger on the right side of the agricultural wagon.

Various embodiments of the invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENTS

An agricultural wagon including an adjustable folding auger is disclosed. Agricultural wagons may be used to receive, store, and dispense a particulate material, such as grain or other harvested crops. The wagons according to the various aspects of the invention may also be referred to as grain wagons or grain carts. Generally, grain carts are used to receive the grain or other material from a transfer vehicle such as a combine. The combine, which is used to harvest an agricultural product, separates the product and dispenses the grain therefrom. The dispensed grain can be stored within the grain cart and the grain cart can be filled subject to a measurement, such as a weight or volume. Once filled, the grain cart, which is generally pulled by a vehicle such as a tractor, can be transported to another location within, around, or away from a field. The product within the grain cart, e.g., grain, can then either be stored in the cart for a later use, or can be dispensed from the cart to another storage vessel. For example, a storage vessel may be a semi-trailer or other trailer for hauling the product to a final storage location. Otherwise, the grain cart can dispense the material directly from the cart and into a final storage vessel. To accomplish the dispensing, the grain cart may utilize one or more augers to move the product from within a storage bin of the grain cart to a location outside the grain cart.

Grain carts typically include at least a lift auger. A lift auger is an auger that moves material from a storage bin of the grain cart upwards and generally away from the storage bin to a location for dispensing the grain. Generally, the lift augers are positioned at the front or side of the grain cart. For example, the auger may be positioned at a left side or left, front corner of a grain cart. The designation of the left side of the grain cart is in relation to the direction of travel of the cart. The positioning of the lift auger at the left side or left, front corner of the grain cart allows the operator in the tractor to be able to see the location of the dispensement of the material from the lift auger and into the storage vessel. Additionally, lift augers generally include a hinge to allow for pivoting or folding of the auger when the auger is not in use and/or when the cart needs to be transported to a different location, for example from one field to the next. The hinge allows the auger to be folded to a position generally in front of or behind the grain cart such that, in a transport or folded position, the auger is folded generally within the front or rear profile of the grain cart. However, incorporating a hinge or pivot point along the lift auger can create engagement or alignment issues at the point of contact between the upper and lower sections of the lift auger when it is in the extended or operating position. Therefore, the grain cart depicted in the figures provides a solution to at least this issue.

As will be understood, the grain cart 10 according to aspects of the invention includes a folding or pivoting style lift auger 32 that comprises an adjustable hinge assembly 45 that utilizes slotted holes 72 to provide axial adjustment of the upper section of the lift auger relative to the lower section. This movement allows for adjustment of the alignment and fit at the point of engagement between the upper and lower sections of the lift auger, which is advantageous in the manufacturing of the grain cart 10, during repair of the auger or other components of the cart, or generally any other time in which the auger needs to be adjusted.

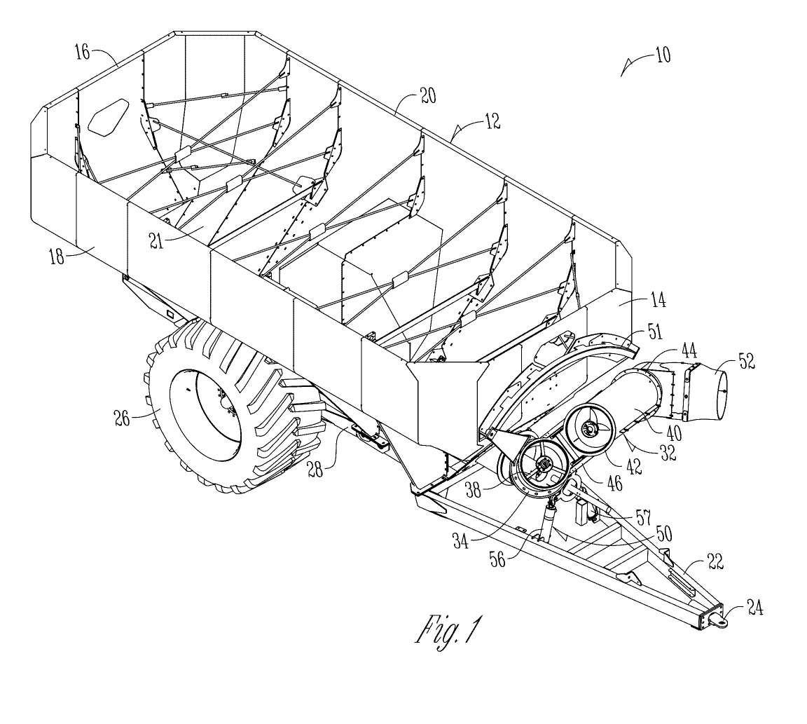

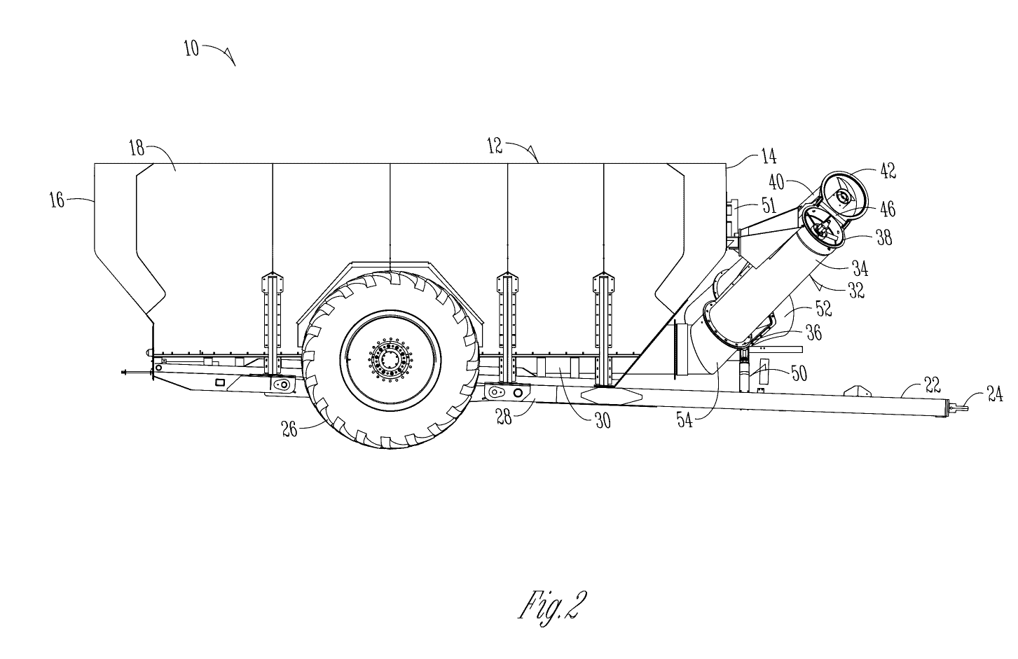

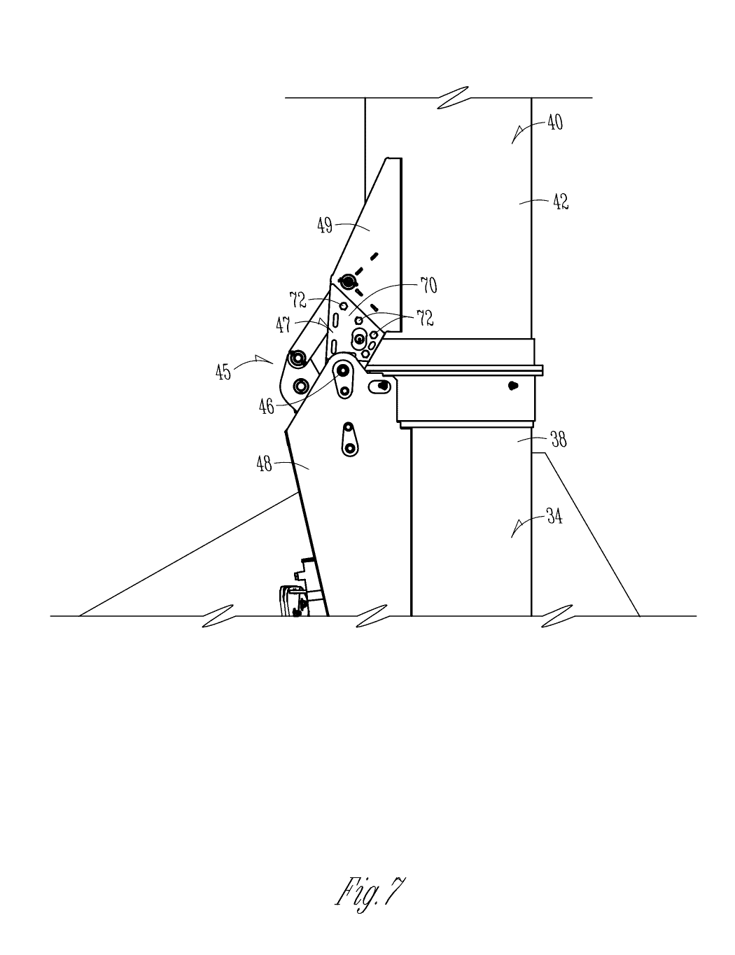

FIGS. 1-8 show a grain cart according to aspects of the present invention. Referring to FIG. 1, a grain cart may include a storage bin 12 defined, in part, by walls. For example, the walls may include a front wall 14, rear wall 16, right wall 18, and left wall 20. The designations of left and right are relative to the direction of travel of the grain cart 10. However, it will be appreciated that the terms could be reversed if viewed by looking at the front of the grain cart 10. The grain cart 10 may also include a floor or portion of a floor 21. The storage bin 12 receives the grain or other material and holds said material therein until a time of dispensing. Also shown is a tongue 22 extending from a frame 28, which supports the storage bin 12. The frame 28 may be a unitary member, or can comprise multiple members, such as to allow independent steering of multiple sets of wheels. For example, when forward and rear wheels are included, the axles of the wheels may be able to move or turn independent of one another. At a forward end of the tongue 22 is a hitch 24 for attaching the agricultural wagon or grain cart 10 to a towing vehicle, such as a tractor. The grain cart 10 is also supported and movable by the inclusion of wheels 26. While the figures show the use of only two wheels, it should be appreciated that the present invention contemplates any number of wheels may be used to support and allow movement for the grain cart 10. In addition, it is contemplated that endless tracks be used instead of wheels, with the tracks being steerable as well.

The grain cart 10 can be operatively connectable to a tractor or other towing vehicle via a control box (not shown in figures). The control box may include a hook up to a power support, such as a power take off of a tractor, an electrical supply, a pneumatic supply, a hydraulic supply, or some combination thereof. The control box may also include controls such as electronic controls, hydraulic controls, pneumatic controls, or the like. These controls may operate the various aspects of the grain cart 10. For example, the control box may include electric controls to control the movement of the augers. Sensors may also be included to constantly update the weight or volume of the product within the storage bin 12. Furthermore, additional aspects such as fans for drying the product and hydraulic controls for controlling hydraulic actuators for the augers and other components of the grain cart 10 may be operated and controlled by the control box.

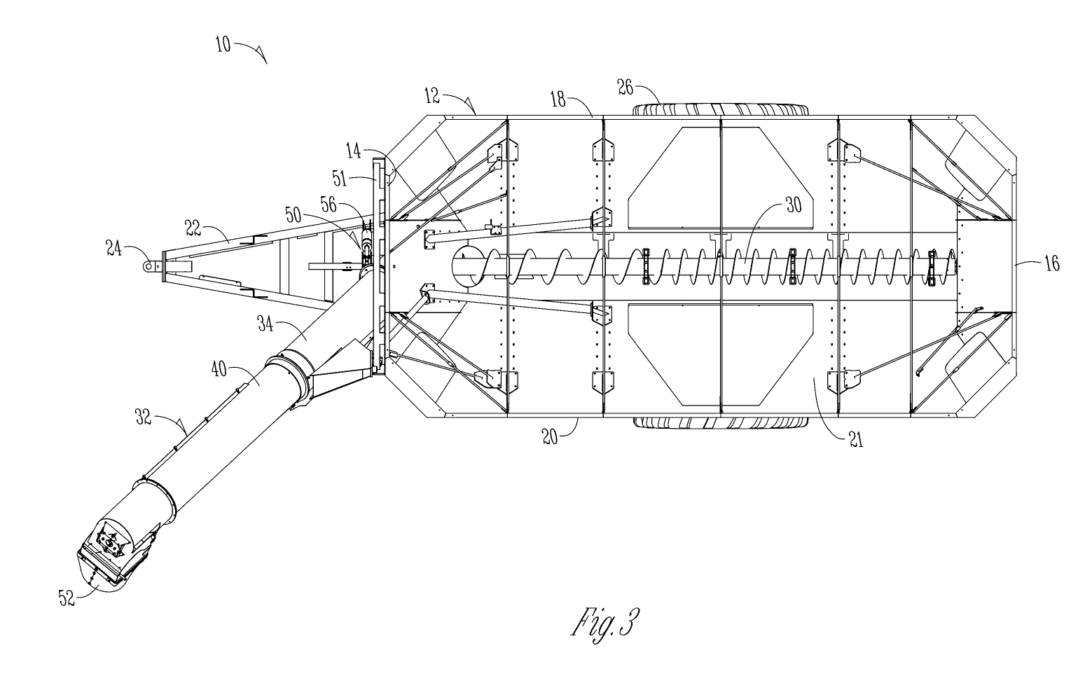

To move the product from within the storage bin 12 to another vessel, the grain cart 10 may incorporate the use of first and second augers 30 and 32, which can also be referred to as floor and lift augers, among other terms. However, it is to be appreciated that the invention contemplates that only a lift auger 32 may be used with the present invention, and the first or floor auger 30 may be removed, while still keeping the scope of the invention intact. As shown in FIG. 3, the floor auger 30 is included as part of the grain cart 10. The floor auger 30 is positioned generally in line with the longitudinal axis of the storage bin 12. The first or floor auger 30 may be positioned within the storage bin 12 or may be placed outside the storage bin 12, such as underneath the storage bin 12 floor. In such a case, the floor 21 of the storage bin 12 may include one or more holes or apertures to allow the grain or other product to fall from the storage bin 12 and into contact or communication with the floor auger 30. The floor auger 30 operates as a standard auger in utilizing a rotational movement of the auger to move the material in a rear to front manner. Thus, as shown in the figures, the operation of the floor auger 30 will move the material in the direction from the rear wall 16 towards the front wall 14. However, it should be appreciated that, in some instances, the auger 30 may be used in the reverse manner to move material from the front of the grain cart 10 towards the rear of the grain cart 10. In such cases, as will be understood, the lift auger 32 may be placed at the rear of the grain cart 10.

Operation of the floor auger 30 may be driven by a tractor, such as by the power takeoff output of the tractor. The power takeoff can be connected to a drive shaft, which is operatively connected to a belt chain, gear chain, or other driven mechanism, which in turn, is operatively connected to the auger 30, such as by being connected to an auger drive. Rotation of the drive shaft by the power takeoff will cause the driven mechanism to rotate, which will in turn, rotate the floor auger 30.

The grain cart 10 shown in the figures discloses a floor auger 30 operatively connected to a lift auger 32. The lift auger 32 shown in FIGS. 1-5 is positioned generally at a front corner of the storage bin 12, and being outside the storage bin 12. This allows for the greatest amount of volume within the storage bin 12, as the lift auger 32 will not take up space within the grain bin 12. However, a portion of or the entire lift auger 32 may be positioned within the storage bin 12, in some instances. The lift auger 32 is in communication with the floor auger 30 such that the grain moved by the floor auger 30 will be communicated to the lift auger 32. The lift auger 32 moves the material from a lower position to a position upward and away from the grain cart 10, such as to a location designated by the hood 52 at the end of the lift auger 32. The hood 52 is utilized to direct the flow of the dispensing of the grain from the lift auger 32. Thus, a communication is provided by the floor 30 and lift augers 32 to move the material from within the storage bin 12 of the grain cart 10 via the lift auger 32 and dispense it towards another storage vessel.

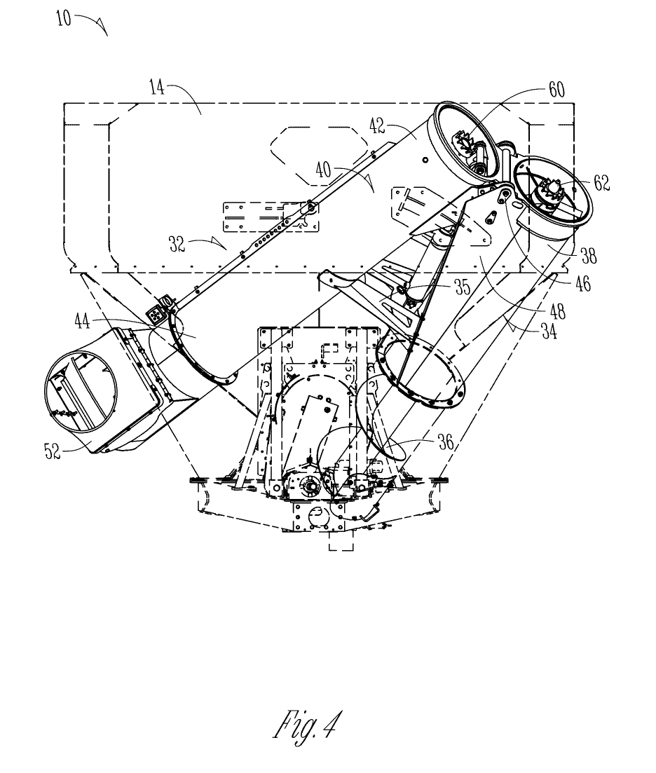

Furthermore, the lift auger 32, as shown in the figures, can be a pivoting or folding style auger. The lift auger 32, as shown in FIGS. 1-7, includes an upper auger section 40 pivotally coupled to a lower auger section 34. For example, as shown in FIG. 4, the lift auger 32 is in a folded or transport position wherein the upper auger section 40 of the lift auger 32 is pivoted relative to the lower auger section 34 of the lift auger 32. When in the folded or transport position, the upper auger section 40 of the lift auger 32 rests generally in one or more saddle members 35 extending from the lower auger section 34. Furthermore, when in the transport or folded position, the lift auger 32 is folded generally within the front or rear profile of the grain cart 10, as shown in FIG. 4. The transport configuration allows the grain cart 10 to be transported from one location to the next without hitting the auger 32 on potential obstructions, such as tree branches, bridges, or telephone poles.

Therefore, to provide for folding of the lift auger 32, the lift auger 32 includes a hinge assembly 45 that allows an upper section 40 to pivot about a lower section 34. The upper section 40 may be pivotable about the lower section 34 by either a first pivot point or a second pivot point. The lower section 34 of the lift auger 32 includes a lower end 36 and an upper end 38. The lower end 36 of the lower section 34 of the lift auger 32 may be operatively connected to the floor auger 30. Thus, the grain conveyed by the floor auger 30 may be communicated to the lower end 36 of the lower section 34 of the lift auger 32. In addition, there may be an auger connector between the floor auger 30 and the lower section 34 of the lift auger 32. This may also be known as the grain transfer case, and is disclosed and shown in more detail in U.S. application Ser. No. 14/603,954, which is hereby incorporate by reference in its entirety. The grain transfer case may be a variable angle auger connector, which includes at least a partially angled component extending from a horizontal component to connect the floor auger 30 to the lift auger 32. The grain transfer case may also be operatively connected to the power takeoff of a tractor pulling the grain cart 10. For example, the auger connector may include a drive mechanism, such as a belt chain or gear chain, which is activated by the power takeoff. Such activation can reorient the auger connector to rotate, pivot, or otherwise cause the lift auger 32 to be moved relative to a first position. The auger 32 may be moved to adjust the height or reach of the end of the auger, or it may be reoriented to position the hood 52 of the auger 32 at the opposite side of the grain cart 10 itself. Furthermore, the auger connector may include a gear or series of gears that, when driven, such as by the power takeoff, will cause the movement of the lift auger 32.

The lower section 34 of the lift auger 32 is operably and/or pivotally connected to an upper section 40 of the lift auger 32. The upper section 40 of the lift auger 32 includes a lower end 42 and an opposite upper end 44. The lower end 42 of the upper section 40 can be pivotally aligned with the upper end 38 of the lower section 34 of the lift auger 32. However, when moved to a folded or transport configuration, the upper end 38 of the lower section 34 can become detached from the lower end 42 of the upper section 40 and the two sections can be pivoted, swiveled, or otherwise moved relative to one another to fold the upper section 40 towards the saddle 35 extending from the lower section 34, as is shown in FIG. 4.

The upper and lower sections 40 and 34 of the lift auger 32 can be pivotally connected to each other by a single pivot point or, according to some aspects of the invention, by two pivot points. When a single pivot point 46 is utilized, the lift auger 32 can be positioned at or near the right, front corner of the grain cart 10 before folding the upper portion 40 relative to the lower portion 34, as is shown in FIG. 1. However, when a first and second pivot point are utilized, the lift auger 32 can be folded when the lift auger 32 is at either the left, front corner of the grain cart 10 or the right, front corner of the grain cart 10. The use of the dual pivot points would allow the upper section 40 of the lift auger 32 to be folded in either direction towards the lower section 34 of the lift auger 32 to place the folded lift auger 32 generally within the front profile of the grain cart 10.

It is contemplated that the lift auger 32 includes a single pivot point 46. As shown in FIGS. 3-5, the typical configuration of the lift auger 32 will be such that it is positioned at the left, front corner of the storage bin 12. Furthermore, the lower section 34 of the lift auger 32 may include a saddle 35 configured and oriented to receive and hold the upper section 40 when folded in the transport configuration of the grain cart 10. The folding and unfolding actuator 64, which can be a hydraulic actuator, pneumatic actuator, electric actuator, or some combination thereof, may be utilized to unfold the lift auger 32 until a portion of it rests within the saddle 35, where it can be held during transport of the grain cart 10. As shown in some of the figures, the saddle 35 is oriented generally at a right side of the lower section 34 of the lift auger 32. Therefore, in such embodiments, the lift auger 32 would have to be positioned at the left, front corner in order to be folded with the upper and lower sections 40 and 34 being within the front profile of the cart. However, it should be appreciated that, according to at least some aspects, a saddle 35 could be included on either side or the single saddle could be positioned on the opposite side such that the lift auger 32 would fold the opposite direction to be positioned in the transport configuration.

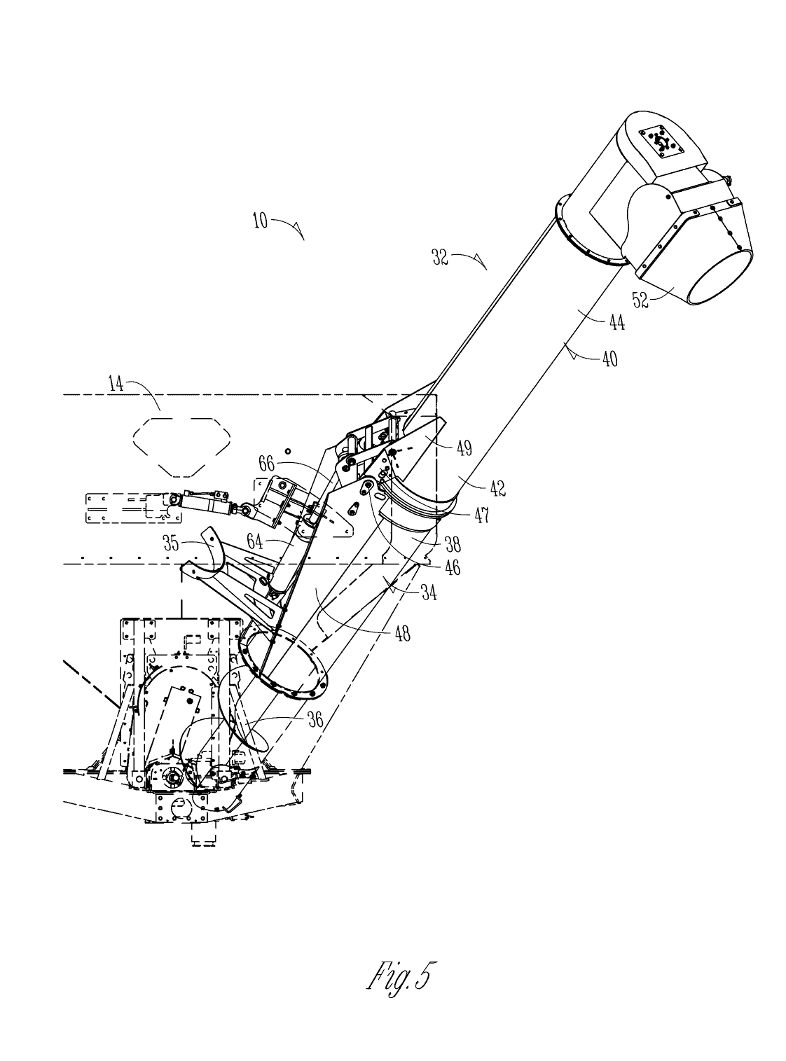

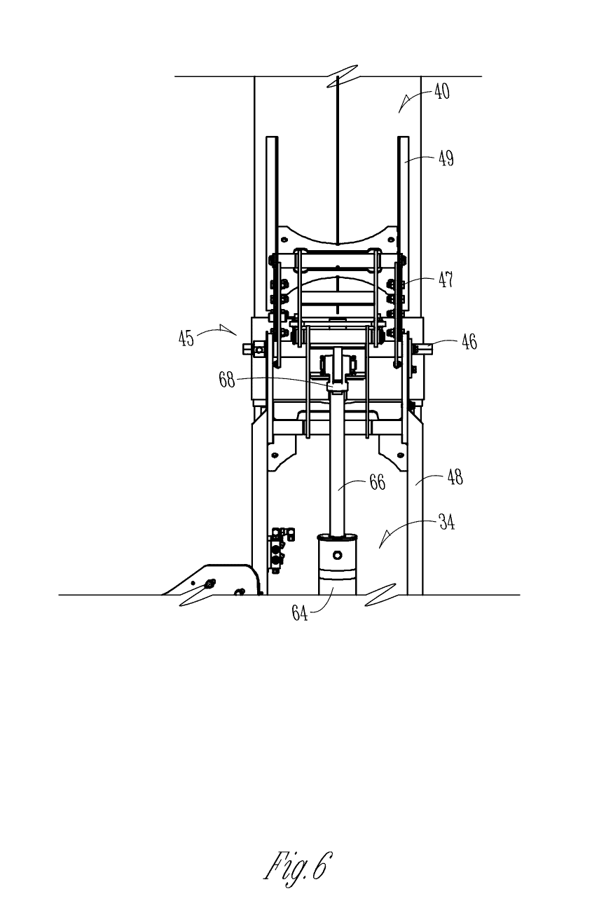

The folding lift auger 32 shown in the figures includes a hinge assembly 45 that defines a pivot axis. As shown in FIG. 6, the hinge assembly 45 is operatively attached to the upper and lower auger sections 40 and 34 by upper and lower mounting brackets 49 and 48. The hinge assembly 45 allows the lift auger 32 to be moved from a folded or transport position, as shown in FIG. 4, to an extended or operating position, as shown in FIG. 5. Conversely, the hinge assembly also allows the lift auger 32 to be moved from an extended position to a folded position. The upper auger section 40 generally includes an upper auger disposed within an upper tubular housing. Similarly, the lower auger section 34 generally includes a lower auger disposed within a lower tubular housing. The upper and lower augers may each include a coupler 60 and 62. The couplers 60 and 62 operatively engage/mate together when the lift auger 32 is in the extended or operating position, and the lower auger can drive the upper auger when the couplers 60 and 62 are engaged.

As disclosed, the hinge assembly 45 may include a hydraulic cylinder 64 or similar mechanism for pivoting the upper auger section 40 about the lower auger section 34. As shown in FIGS. 5-6, the cylinder 64 includes a piston rod 66. The piston rod 66 may be connected to the hinge assembly 45 by a clevis 68. In one embodiment of the invention, the clevis 68 may be attached to the piston rod 66 via a threaded connection. For example, the tip of the piston rod 66 may include threads on the outer surface and the clevis 68 may include an aperture with interior threads configured to attach the clevis 68 to the piston rod 66 via the threads. Attaching the clevis 68 to the piston rod 66 via a threaded connection may allow for adjustment of the length of the piston rod 66. For example, a longer piston rod 66 may be required to provide an increased angular rotation of the upper auger section 40 relative to the lower auger section 34. The clevis 68 may be un-threaded a few rotations, relative to the piston rod 66, to lengthen the piston rod 66. Conversely, the clevis 68 may be further threaded onto the piston rod 66 to shorten the length of the piston rod 66, reducing the angular rotation of the upper auger section 40 relative to the lower auger section 34. Other methods of attaching the clevis 68 to the piston rod 66 are also contemplated, such as a pin-type fastener. For example, the rod 66 and clevis 68 may each include an aperture configured to attach the rod to the clevis via a bolt or pin being inserted through the aperture, and a nut or split pin to secure them in place. A weld or epoxy is also contemplated as a means of attaching the clevis 68 to the rod 66. Furthermore, the rod 66 may be attached to the hinge assembly without using a clevis 68. For example, using a bolt or pin through an aperture at the end of the rod 66 to connect to the hinge assembly 45 is contemplated. The clevis 68 may be attached to the hinge assembly 45 by a pin-type fastener or similar means of attachment that allows for the piston rod 66 to rotate the upper auger section 40 about the lower auger section 34. When the piston rod 66 is extended, the upper auger section 40 will be pivoted about to the lower auger section 34, thus the lift auger 32 will move from a folded position to the extended or operating position. Conversely, when the piston rod 66 is retracted, the lift auger 32 will be moved from the extended position to the transport or folded position.

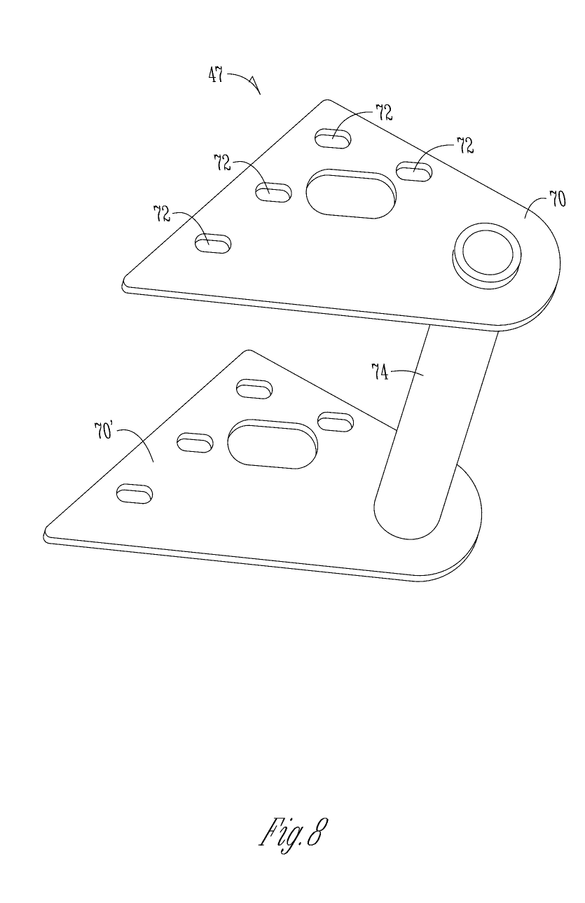

The hinge assembly 45 further includes a linkage bar 47, best shown in FIG. 8, that comprises two opposing hinge plates 70 and 70′ connected by a rod 74. The linkage bar 47 operatively connects the upper and lower mounting brackets 49 and 48 utilizing one or more fasteners (fasteners not shown in the figures so as to better disclose the slotted holes) through one or more slotted holes 72. The number of slotted holes 72, as well as the location of and/or the pattern of the slotted holes 72 on the hinge plate 70 may be adapted to fit a hinge assembly 45 of various sizes and configurations. Furthermore, the size, shape, and/or length of the one or more slotted holes 72 may be adapted to fit varying sizes of fasteners and/or to provide varying amounts of axial adjustment. For example, using a larger diameter fastener may require a longer slotted hole 72 to provide the appropriate amount of axial adjustment. The linkage bar 47 defines the pivot axis about which the upper auger section 40 pivots relative to the lower auger section 34. When in the extended position, the upper and lower sections of the auger 40 and 34 matingly engage with one another, such that opposing flanges attached to the lower end 42 of the upper auger section 40 and the upper end 38 of the lower auger section 34 abut one another. The hinge plate 70 includes a plurality of slotted holes 72. The slotted holes 72 may provide axial adjustment of the upper auger section 40 relative to the lower auger section 34. For example, the upper and lower mounting brackets 49 and 48 may be operatively attached to the linkage bar 47 via one or more fasteners being inserted through one or more of the slotted holes 72. The plurality of fasteners may further be slid along the track/channel created by the slotted holes to axially adjust the upper auger section 40 relative to the lower auger section 34. One example of an advantage provided by the slotted holes 72 of the linkage bar 47, is that the slotted holes 72 should provide axial adjustment of the upper auger section 40 which will allow the flanges of the upper and lower auger sections 40 and 34 to more completely engage at the points of contact. This creates a better mated engagement between the upper and lower sections such that it mitigates a space therebetween, which aids in preventing the loss of the particulate material as it moves through the auger.

An example method for adjusting the hinge assembly 45 described above may include providing a linkage bar 47 that includes one or more slotted holes 72. It may further include attaching an upper and lower auger section 40 and 34 by inserting one or more fasteners through the one or more slotted holes 72 of the linkage bar 47. Once the upper and lower auger sections 40 and 34 are operatively attached via the hinge assembly 45, including the linkage bar 47 with slotted holes 72, the upper auger section 40 may be pivoted about the lower auger section 34 to position the auger 32 in the extended position. When the auger 32 is in the extended position, the one or more fasteners may be slid or adjusted within the one or more slotted holes 72 to allow for axial adjustment of the upper auger section 40 relative to the lower auger section 34. Once the upper auger section 40 is adjusted relative to the lower auger section 34, the fasteners through the slotted holes 72 may be tightened to affix the orientation of/relationship between the linkage bar 47 and the upper and lower mounting brackets 49 and 48.

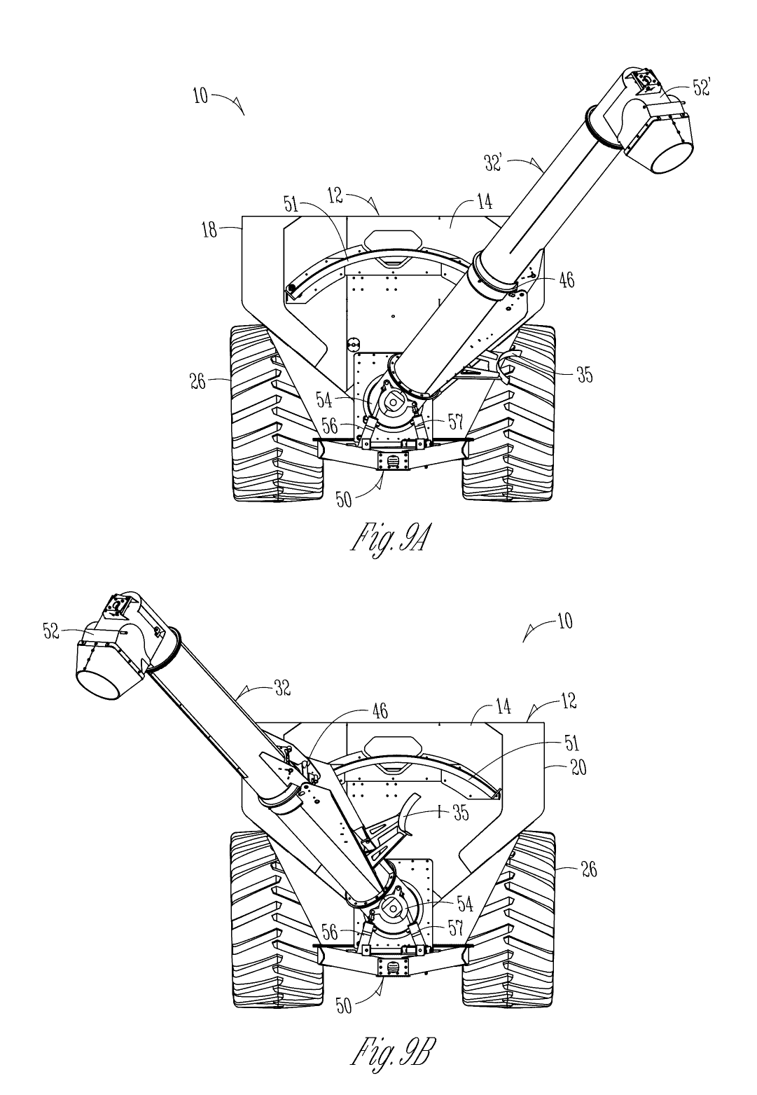

The lift auger 32, as shown in FIG. 9, can be moved from a left, front corner to a right, front corner of the grain cart 10, or vice versa. This allows the operator to dispense particulate material on either side of the grain cart 10. Such a configuration is shown and described in U.S. application Ser. No. 14/603,954, which is hereby incorporated by reference in its entirety. For example, as shown in FIG. 9B, the lift auger 32 is positioned at the front, right corner of the cart 10, while FIG. 9A shows the lift auger 32′ positioned at the front, left corner of the cart 10. The lift auger 32, 32′ can be moved via a control mechanism 50. For example, as shown in FIG. 9, the control mechanism includes a rotatable grain transfer case 54, first and second actuators 56 and 57 connected to a rocker device, and a guide member 51. One potential advantage provided by the movement of the lift auger 32 includes the ability to dispense on either side of the grain cart 10. The ability to move the lift auger 32 from one side of the grain cart 10 to the other provides the ability to be more flexible when positioning the grain cart 10 relative to the storage vessel, which is to receive the grain. Thus, the movement of the lift auger 32 from one side of the cart 10 to the other can provide greater efficiency in moving and transporting grain, which will decrease the amount of time needed to unload the grain, which will in turn decrease the overall time of harvest.

Therefore, the inclusion of the hinge assembly 45 according to aspects of the invention will provide numerous advantages. The hinge will allow for flexibility of the upper and lower sections of the lift auger to aid in matingly engaging the components to mitigate the possibility of space therebetween. This will aid in preventing the loss of particulate material as it is transferred through the lift auger. The assembly will allow the adjustment of the auger during and after manufacturing of the grain cart, such that imperfections that arise due to the use of the cart can be improved upon by slight adjustments made to the hinge assembly. Still other advantages are included.

An agricultural wagon or grain cart including an adjustable hinge assembly capable of providing axial adjustment of an upper section of a folding auger relative to a lower section of the auger has thus been described. The present invention contemplates numerous variations, options and alternatives, and is not to be limited to the specific embodiments described herein. Other changes are considered to be part of the present invention.

What is claimed is:

1. An agricultural wagon, comprising:
a storage bin adapted to connect to a vehicle, the bin including front, rear, and laterally opposed side walls;
a lift auger in communication with an interior of the storage bin, said lift auger comprising an upper auger member having a discharge end opposite a lower end, and a lower auger member having an upper end opposite an intake end; and
wherein the lower end of the upper auger member is pivotably attached by a hinge assembly to the upper end of the lower auger member, said hinge assembly comprising at least one slotted hole configured to provide axial adjustment of the upper auger member relative to the lower auger member to adjust the engagement of the upper auger member and the lower auger member of the lift auger.

2. The agricultural wagon of claim 1, further comprising a floor auger operatively connected to the storage bin and configured to move particulate material in a generally forward or rearward direction relative to the interior of the storage bin.

3. The agricultural wagon of claim 2, wherein the intake end of the lift auger is operatively connected to the floor auger and configured to receive the particulate material from the floor auger.

4. The agricultural wagon of claim 3, further comprising a transfer case rotatably connected to the storage bin and comprising a connection between the floor auger and the lift auger.

5. The agricultural wagon of claim 1, further comprising a cylinder operatively attached to the hinge assembly and configured to pivot the upper auger member about the lower auger member.

6. The agricultural wagon of claim 5, wherein the cylinder comprises a piston and a rod, the rod comprising a threaded clevis configured to provide angular adjustment of the upper auger member relative to the lower auger member when the upper auger member is pivoted about the lower auger member.

7. The agricultural wagon of claim 1, further comprising a dispensing hood operatively connected to the lift auger for directing the particulate material from said auger and being movable relative to the lift auger to change a characteristic of the dispensement.

8. The agricultural wagon of claim 1, further comprising a lower engagement flange attached to the upper end of the lower auger member.

9. The agricultural wagon of claim 8, further comprising an upper engagement flange attached to the lower end of the upper auger member.

10. The agricultural wagon of claim 9, wherein the upper engagement flange and the lower engagement flange are configured to matingly engage when the lift auger is in an operating position.

11. The agricultural wagon of claim 1, wherein the lift auger is adapted to be positioned to move the material at either side of the storage bin and capable of moving from one side to the other

12. The agricultural wagon of claim 1, wherein the hinge assembly comprises a linkage bar configured to operatively couple the upper auger member to the lower auger member, and said linkage bar comprises at least one slotted hole.

13. A folding lift auger for use with an agricultural grain cart, comprising:
a lift auger configured to move a particulate material;
wherein the lift auger includes an upper auger member having a discharge end opposite a lower end, and a lower auger member having an upper end opposite an intake end; and
wherein the lower end of the upper auger member is pivotally attached by a hinge assembly to the upper end of the lower auger member, said hinge assembly comprising at least one slotted hole configured to provide axial adjustment of the upper auger member relative to the lower auger member to adjust the engagement of the upper auger member and the lower auger member of the lift.

14. The folding auger of claim 13, wherein said hinge assembly comprises a linkage bar configured to operatively couple the upper auger member to the lower auger member.

15. The folding auger of claim 14, wherein said linkage bar comprises at least one slotted hole configured to provide axial adjustment of the upper auger member relative to the lower auger member.

16. The folding auger of claim 14, wherein the linkage bar comprises a first bar and an opposing second bar, said first bar and said second bar connected by a shaft.

17. A method of adjusting a folding lift auger, said method comprising:
Providing a hinge assembly for connection of an upper auger member and a lower auger member of the folding lift auger, said hinge assembly comprising at least one slotted hole, said at least one slotted hole configured to provide axial adjustment of the folding lift auger wherein the axial adjustment of the upper auger member is relative to the lower auger member.

18. The method of claim 17, further comprising the step of attaching the hinge assembly to the upper auger member and the lower auger member of a folding lift auger, said hinge assembly comprising a cylinder with a threaded clevis and configured to pivot the upper auger member about the lower auger member.

19. The method of claim 18, further comprising the step of adjusting the upper auger member and the lower auger member of the folding lift auger via the at least one slotted hole of the hinge assembly to provide mating engagement between the upper auger member and the lower auger member.

20. The method of claim 19, wherein the step of adjusting the upper auger member via the hinge assembly further comprises adjusting the threaded clevis of the cylinder, said threaded clevis configured to adjust the angle of the upper auger member relative to the lower auger member.
